(19) United States
(12) Patent Application Publication
(10) Pub. No.: US 2025/0227158 A1
(43) Pub. Date: Jul. 10, 2025

(54) SYSTEM AND METHOD FOR MANAGING STATUS OF O-CLOUD RESOURCE

(71) Applicant: RAKUTEN SYMPHONY, INC., Tokyo (JP)

(72) Inventor: Manmeet Singh BHANGU, Indore (IN)

(73) Assignee: RAKUTEN SYMPHONY, INC., Tokyo (JP)

(21) Appl. No.: 18/293,621

(22) PCT Filed: Aug. 28, 2023
(86) PCT No.: PCT/US2023/031216

§ 371 Date: Jan. 30, 2024

(30) Foreign Application Priority Data
Mar. 24, 2023 (IN) 202341021189

(51) Int. Cl. H04L 67/54; H04L 43/0817

(52) U.S. Cl. CPC H04L 67/54; H04L 43/0817

(57) ABSTRACT

Provided are a method, system, and device for changing the status of an Open Radio Access Network (O-RAN) Cloud (O-Cloud) resource, the method may include: obtaining, by a Service Management and Orchestration Framework (SMO) function, a first request or recommendation to update a functional status of an O-Cloud resource, the first request or recommendation being obtained from an rApp of a Non-Real-Time (Non-RT) RAN Intelligent Controller (RIC), or from an O-Cloud Maintainer, or from the SMO function directly; transmitting, by the SMO function to an Infrastructure Management Services (IMS), a second request to update the functional status of the O-Cloud resource based on the received first request or recommendation; and receiving, by the SMO function from the IMS, a first response as to whether the functional status of the O-Cloud resource was updated.

### FIELD

System and methods consistent with example embodiments of the present disclosure relate to managing the functional status of an open radio access network (O-RAN) cloud (O-Cloud) resource.

### BACKGROUND

A radio access network (RAN) is an important component in a telecommunications system, as it connects end-user devices (or user equipment) to other parts of the network. The RAN includes a combination of various network elements (NEs) that connect the end-user devices to a core network. Traditionally, hardware and/or software of a particular RAN is vendor specific.

Open RAN (O-RAN) technology has emerged to enable multiple vendors to provide hardware and/or software to a telecommunications system. To this end, O-RAN disaggregates the RAN functions into a centralized unit (CU), a distributed unit (DU), and a radio unit (RU). The CU is a logical Node for hosting Radio Resource Control (RRC), Service Data Adaptation Protocol (SDAP), and/or Packet Data Convergence Protocol (PDCP) sublayers of the RAN. The DU is a logical Node hosting Radio Link Control (RLC), Media Access Control (MAC), and Physical (PHY) sublayers of the RAN. The RU is a physical Node that converts radio signals from antennas to digital signals that can be transmitted over the FrontHaul to a DU. Because these entities have open protocols and interfaces between them, they can be developed by different vendors.

FIG. 1 illustrates a related art O-RAN architecture. Referring to FIG. 1, RAN functions in the O-RAN architecture are controlled and optimized by a RIC. The RIC is a software-defined component that implements modular applications to facilitate the multivendor operability required in the O-RAN system, as well as to automate and optimize RAN operations. The RIC is divided into two types: a non-real-time RIC (Non-RT RIC) and a near-real-time RIC (Near-RT RIC).

The Non-RT RIC is the control point of a non-real-time control loop and operates on a timescale greater than 1 second within the Service Management and Orchestration (SMO) framework. Its functionalities are implemented through modular applications called rApps (rApp 1, . . . , rApp N), and include: providing policy-based guidance and enrichment across the AI interface, which is the interface that enables communication between the Non-RT RIC and the Near-RT RIC; performing data analytics; Artificial Intelligence/Machine Learning (AI/ML) training and inference for RAN optimization; and/or recommending configuration management actions over the O1 interface, which is the interface that connects the SMO to RAN managed elements (e.g., Near-RT RIC, O-RAN centralized Unit (O-CU), O-RAN Distributed Unit (O-DU), etc.).

The Near-RT RIC operates on a timescale between 10 milliseconds and 1 second and connects to the O-DU, O-CU (disaggregated into the O-CU control plane (O-CU-CP) and the O-CU user plane (O-CU-UP)), and an open evolved NodeB (O-eNB) via the E2 interface. The Near-RT RIC uses the E2 interface to control the underlying RAN elements (E2 Nodes/network functions (NFs)) over a near-real-time control loop. The Near-RT RIC monitors, suspends/stops, overrides, and controls the E2 Nodes (O-CU, O-DU, and O-eNB) via policies. For example, the Near-RT sets policy parameters on activated functions of the E2 Nodes. Further, the Near-RT RIC hosts xApps to implement functions such as quality of service (QOS) optimization, mobility optimization, slicing optimization, interference mitigation, load balancing, security, etc. The two types of RICs work together to optimize the O-RAN. For example, the Non-RT RIC provides, over the AI interface, the policies, data, and AI/ML models enforced and used by the Near-RT RIC for RAN optimization, and the Near-RT returns policy feedback (i.e., how the policy set by the NON-RT RIC works).

The SMO framework, within which the Non-RT RIC is located, manages and orchestrates RAN elements. Specifically, the SMO includes the Federated O-Cloud Orchestration and Management (FOCOM), a Network Function Orchestrator (NFO) that manages Virtual Machines (VM) based Virtual Network Functions (VNF) and container (i.e., instance) based VNF, and the OAM as a part of the SMO that manages and orchestrates what is referred to as the O-RAN Cloud (O-Cloud). The O-Cloud is a set of hardware and software components that provide cloud computing capabilities and services to execute RAN network functions, which may include a collection of physical RAN Nodes that host the RICs, O-CUs, and O-DUs, the supporting software components (e.g., the operating systems and runtime environments), and the SMO itself. In other words, the SMO manages the O-Cloud from within. The O2 interface is the interface between the SMO and the O-Cloud it resides in. Through the O2 interface, the SMO provides Infrastructure Management Services (IMS) and Deployment Management Services (DMS). The O2 interface may also send O2 telemetry data to the SMO, e.g., O-Cloud configuration or any logical function data, energy consumption, health status of Node, etc.

In the related art, the O-Cloud resources may need to have their status changed (for example, set into maintenance mode) in order to properly manage workloads. Specifically, it may be necessary that resource allocation is managed efficiently, and that critical sensitive workloads are not placed on specific O-Cloud nodes which have performance issues. Setting a status for O-Cloud resources may give a sense of the current performance and fault situation. Accordingly, there is a need to be able to manage the state and status of O-Cloud resources accordingly

### SUMMARY

Example embodiments of the present disclosure provide a method and system for the SMO and O-Cloud to update the functional status of O-Cloud resources based on recommendations from an rApp or manually by an O-Cloud Maintainer via the SMO. In particular, the SMO may send a request to the IMS based on a determination to update the functional status of an O-Cloud resource. In response, the IMS may update the status of the O-Cloud resource and send a response back to the SMO. Accordingly, embodiments of the present disclosure may allow the status of the O-Cloud resource to be readily managed, and facilitate resource allocation management.

According to an embodiment, a method may be provided for changing the status of an Open Radio Access Network (O-RAN) Cloud (O-Cloud) resource. The method may include: obtaining, by a Service Management and Orchestration Framework (SMO) function, a first request or recommendation to update a functional status of an O-Cloud resource, the first request or recommendation being received from an rApp of a Non-Real-Time (Non-RT) RAN Intelligent Controller (RIC), or from an O-Cloud Maintainer, or from the SMO function directly; transmitting, by the SMO function to an Infrastructure Management Services (IMS), a second request to update the functional status of the O-Cloud resource based on the received first request or recommendation; and receiving, by the SMO function from the IMS, a first response as to whether the functional status of the O-Cloud resource was updated.

The first request or recommendation may be determined based on metric and/or observability data received by the rApp or the O-Cloud Maintainer via O1- and/or O2-related services.

The first response may indicate that the functional status was successfully updated. The first response may indicate that the O-Cloud resource could not be found and the functional status could not be updated. The first response may indicate that the functional status could not be updated and an unexpected error occurred.

The functional status update may include setting the O-Cloud resource into maintenance mode.

The method may further include: sending, by the SMO function, a second response to the rApp or O-Cloud maintainer based on the first response as to whether the functional status of the O-Cloud resource was updated.

According to an embodiment, an apparatus for changing the status of an Open Radio Access Network (O-RAN) Cloud (O-Cloud) resource may be provided. The apparatus may include: at least one memory storing computer-executable instructions; and at least one processor configured to execute the computer-executable instructions to: obtain, by a Service Management and Orchestration Framework (SMO) function, a first request or recommendation to update a functional status of an O-Cloud resource, the first request or recommendation being obtained from an rApp of a Non-Real-Time (Non-RT) RAN Intelligent Controller (RIC), or from an O-Cloud Maintainer, or from the SMO function directly; transmit, by the SMO function to an Infrastructure Management Services (IMS), a second request to update the functional status of the O-Cloud resource based on the received first request or recommendation; and receive, by the SMO function from the IMS, a first response as to whether the functional status of the O-Cloud resource was updated.

The at least one processor may be further configured to execute the computer-executable instructions to: send, by the SMO function, a second response to the rApp or O-Cloud maintainer based on the first response as to whether the functional status of the O-Cloud resource was updated.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 illustrates an O-RAN architecture according to the related art;

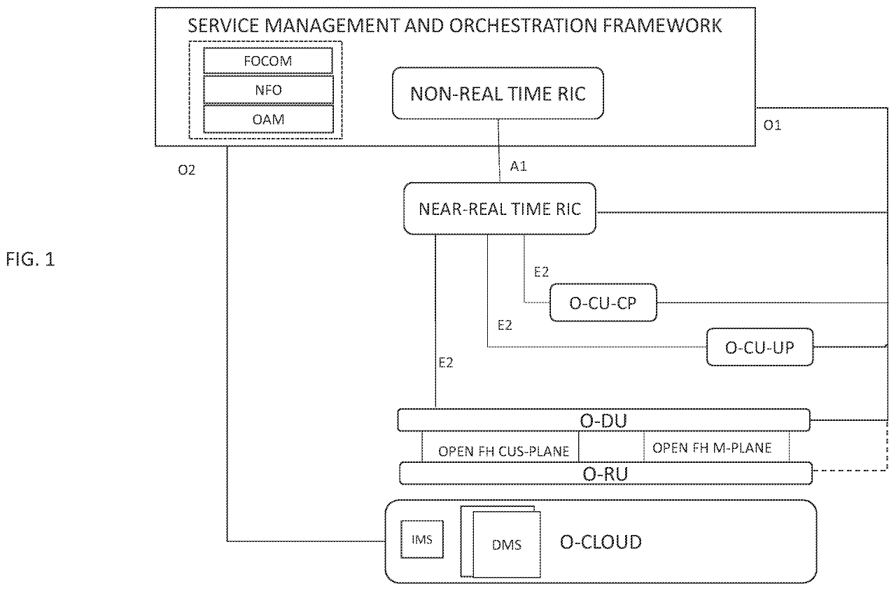

FIG. 2 illustrates a flowchart of a method for updating the functional status of an

O-Cloud resource according to an embodiment;

FIG. 3 illustrates a detailed callflow diagram for implementing IMS functional status update for updating the functional status of an O-Cloud resource according to an embodiment;

FIG. 4 illustrates a diagram of an example environment in which systems and/or methods, described herein, may be implemented; and

FIG. 5 illustrates a diagram of example components of a device according to an embodiment.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Example embodiments are directed to O-Cloud resource optimization, which is a process of utilizing O-Cloud resources in an efficient manner and eliminating waste of O-Cloud resources by selecting, provisioning, and rightsizing the resources within the O-Cloud. In accordance with example embodiments, Network Functions (NFs) within the O-Cloud are orchestrated as VNFs/CNFs. The SMO (NFO, FOCOM) handles the management and orchestration of VNFs/CNFs and underlying O-Cloud infrastructure. The SMO's management, orchestration, and optimization functionalities can be enhanced in accordance with example embodiments by intelligent observability analysis from VNFs/CNFs and O-Cloud.

The Non-RT RIC hosts third-party applications such as rApps in the SMO, which can collect and read various O1 and O2-related observability data and metrics through O1 and O2 related services. These third-party rApps can be leveraged in example embodiments to provide guidance and/or recommendations to the NFO and FOCOM for management, orchestration, and optimization of VNFs/CNFs and underlying O-Cloud infrastructure.

Example embodiments of the present disclosure provide a method and system for the SMO and O-Cloud to update the functional status of O-Cloud resources based on recommendations from an rApp or manually by an O-Cloud Maintainer via the SMO. In particular, the SMO may send a request to the IMS based on a determination to update the functional status of an O-Cloud resource. In response, the IMS may update the status of the O-Cloud resource and send a response back to the SMO. Accordingly, embodiments of the present disclosure may allow the status of the O-Cloud resource to be readily managed, and facilitate resource allocation management.

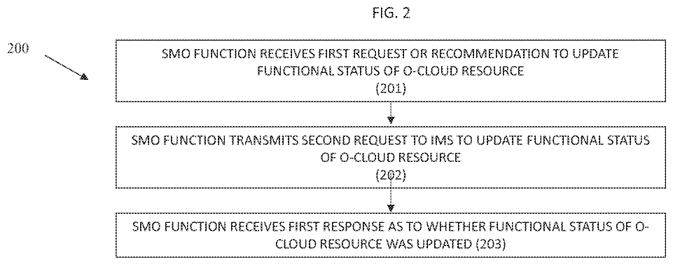

FIG. 2 is a flowchart of a method 200 for updating the functional status of an O-Cloud resource according to an embodiment. One of the goals of method 200 may be to allow an SMO function (e.g., using the FOCOM) or rApps (via nRT-RIC) to request to update the functional status of the O-Cloud Resources. Accordingly, the state and status information of O-Cloud resources may be updated.

In method 200, an O-Cloud operator may be a Cloud Service Provider (CSP) or entity which is using the SMO. The term FOCOM and SMO may be used interchangeably, nevertheless it should be noted that the FOCOM within the SMO is used to represent the initiator of the Functional Status Update request. The IMS in the O-Cloud will respond to the Functional Status Update request. The rApp may be provided via Non-RT RIC according to embodiments. It is assumed in this example method 200 that managed objects refer to underlying O-Cloud Resources, so interactions are shown towards the IMS. Nevertheless, it is contemplated that the functional status update may be done on various types of managed objects, (e.g., objects managed by the DMS). It can be assumed that in method 200, the O-Cloud is operational, the SMO (FOCOM) has connectivity to IMS, security authorization and privilege access have been established between the SMO (FOCOM) and IMS, that O1 & O2 events have been subscribed by the monitoring system supervised by O-Cloud Operator and/or rApp, and that a Performance Management Job is created at the IMS. It should be noted, however, that while the example method utilizes an IMS in this case, a DMS may instead be used for other O-Cloud objects/resources as explained above.

It can also be assumed that a Service Request to the SMO includes the identifiers of the managed object(s) to be updated, and that a trigger to update managed object(s) is received from the FOCOM based on a request from O-Cloud Operator, or recommendation from rApp (excluding the case where the trigger is from the SMO itself).

Referring to FIG. 2, the SMO function may receive a first request or recommendation to update the functional status of an O-Cloud resource at operation S201. This may be transmitted by the O-Cloud operator (manually requested via a user terminal) or the one or more rApps of the Non-RT RIC within the SMO (by a recommendation from the rApp), or initiated by the SMO itself directly. According to embodiments, the rApp may be a hosted application by the Non-RT RIC in the SMO. The rApp may be from a third party. The rApps may collect and read various O1 and O2-related observability data and metrics through O1 and O2 related services. Accordingly, the rApp may be used in some embodiments to provide guidance and- or recommendations to the FOCOM for management, orchestration, and optimization of VNFs and/or container network functions (CNFs) and underlying O-cloud infrastructure. It should be appreciated while the above examples are specified as to which entity may initiate the request, other entities with proper credentials can initiate a functional status update.

According to an embodiment, the rApp may use a data driven approach for providing recommendations to the SMO based on the O1 and O2-related observability data and metrics. For example, O-Cloud Node(s) CPU utilization, O-Cloud Node(s) Memory utilization, and O-Cloud Node(s) Disk utilization may be exposed from the O-Cloud to the FOCOM and rApp, and correlated with other O1 telemetry data related to network traffic in order to determine whether or not to provide a recommendation to initiate a functional status update. Thus, according to some embodiments, the request or recommendation may be determined based on such metrics and/or observability data received by the rApp and/or O-Cloud maintainer via the O1 and/or O2 related services.

It should be appreciated that other data aside from O1 and O2 related observability data and metrics may be used in some embodiments for providing the recommendations. It should be appreciated that there are various scenarios in which there is a need to update the functional status. One example scenario could be where an rApp, with the help of artificial intelligence and/or machine learning (AI/ML) can be used to provide insights to the FOCOM regarding metrics. Accordingly, in some embodiments, artificial intelligence and/or machine learning (AI/ML) may be used.

According to embodiments, rApps can recommend changing the “state” of O-Cloud Resources to the FOCOM. This may include changing the state to maintenance mode. This ensures that critical performance-sensitive workloads are not placed on specific O-Cloud Nodes. The state change can be realized by actions such as O-Cloud Node(s) cordoning (e.g., marking an O-Cloud Node as unschedulable). Performing maintenance operations in the O-Cloud Platform can either be autonomously/automatically or on demand. Switching the operational mode of O-Cloud Node(s) into the Maintenance Mode when an O-Cloud Node within an O-Cloud Node Cluster requires maintenance or is scheduled for decommissioning, can be done by cordoning and draining concepts, according to embodiments. Once the maintenance activity is finished, the O-Cloud Node Cluster is ready to autonomously/automatically or on demand accept the workloads of that O-Cloud Node(s), can be done by un-cordoning. It should be appreciated that some logical resources: (the O-Cloud in aggregate, and O-Cloud Resource pools) which are a collection of resources may or may not have a status. It should also be noted that while a maintenance mode is mentioned as an example of a status, the status may be any state indicators which gives a sense of the current performance and current fault situation for the O-Cloud Resource.

At operation S202, the FOCOM transmits a request to the IMS to update the functional status of the O-Cloud resource based on the request/recommendation received in operation S201. Accordingly, based on this request, the IMS may update the functional status of the O-Cloud resource, for example, by setting it to maintenance mode). It should be appreciated that cordoning is one of the actions taken into consideration when setting O-Cloud Node(s) into maintenance mode, and conversely, uncordoning is one of the actions taken into consideration when taking the O-Cloud Node(s) out of maintenance mode. While maintenance mode is described above as an example, other types of status updates are possible.

At operation S203, the FOCOM receives a response from the IMS based on the result of operation S202, as to whether the status of the O-Cloud Node was updated. Typically, this may indicate that the O-Cloud Node was updated successfully. However, if an error/exception occurred, several other alternative responses are possible. For example, it may indicate that the status object was not found, which is an exception case wherein the managed object to be updated was not found, (i.e., a status update was requested to be performed on a non-existent O-Cloud resource. Alternatively, an exception which is not explicitly pre-defined may occur, in which case, the response may simply indicate that an “other update failure” occurred, which is conveyed to the FOCOM.

According to some embodiments, it may be necessary for the FOCOM to return the status update response to the O-Cloud operator. Accordingly, the FOCOM may send a response to the O-Cloud operator based on the response received from the IMS.

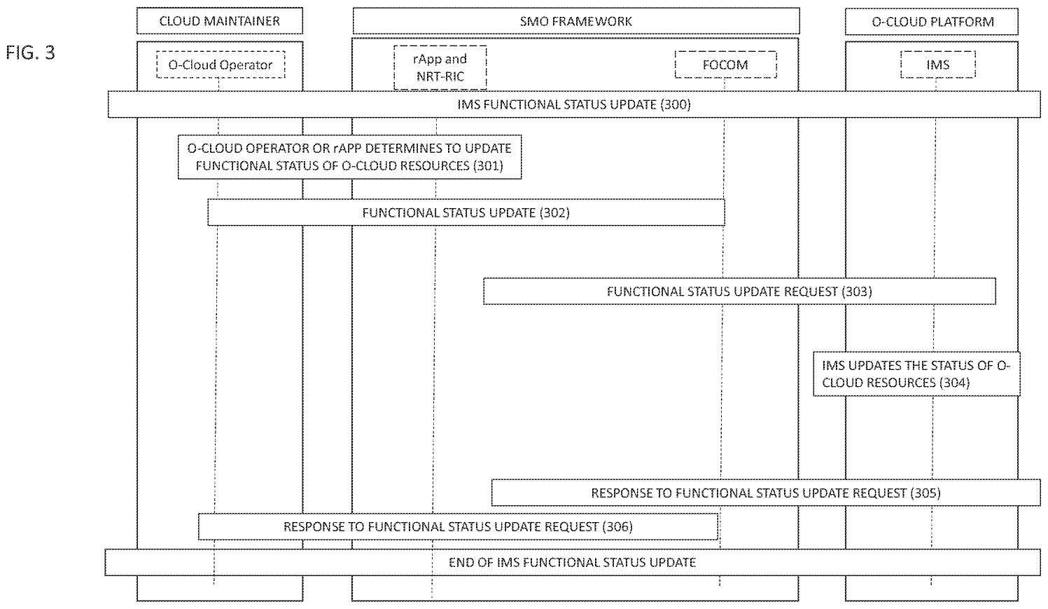

FIG. 3 illustrates a detailed callflow diagram for implementing IMS functional status update 300 for updating the functional status of an O-Cloud resource according to an embodiment. Operations in IMS functional status update 300 may be similar to operations in method 200 illustrated in FIG. 2 above, and accordingly redundant descriptions may be omitted for readability.

In operation 301, the O-Cloud operator or rApp may determine to update the functional status update of the O-Cloud resource(s). This may be based on metrics and/or observability data received from O1 and/or O2 services as explained with reference to operation S201 described in FIG. 2 above. It should be appreciated that operation 301 may be optional in some embodiments, since the request to update the functional status update may be manually initiated in some embodiments.

In operation 302, a request or recommendation is sent to the FOCOM from either the O-Cloud operator, the rApp, or initiated by the FOCOM itself. This step may be similar to operation S201 described in FIG. 2 above. This request or recommendation may be based on the determination in operation 301 according to some embodiments.

In operation 303, a functional status update request is sent by the FOCOM to the IMS based on the request or recommendation in operation 302 above. This step may be similar to operation S202 described in FIG. 2 above.

In operation 304, the functional status update is performed by the IMS based on the functional status update request sent in operation 303.

In operation 305, based on the result of the functional status update performed in operation 304, the IMS may optionally send a response to the FOCOM. This may either indicate that the update was successful, that the object to be updated was not found, or that some other update failure occurred. This may be similar to operation S203 described in FIG. 2 above.

In operation 306, which is an optional step, the FOCOM may forward the response received in operation 305 to the O-Cloud maintainer or the rApp.

Based on the above embodiments, it can be understood that since the SMO (FOCOM) can readily request the IMS to update the status of the O-Cloud resources, the status of the O-Cloud resource to be readily managed, and accordingly facilitate resource allocation management.

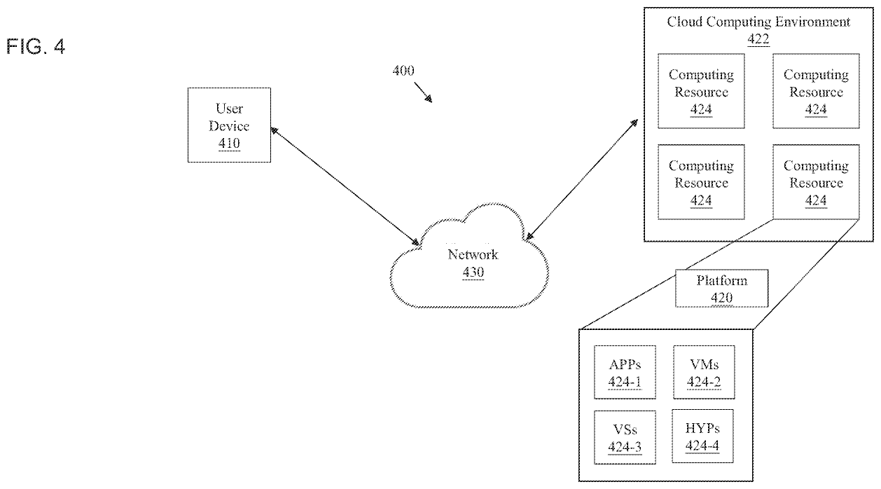

FIG. 4 is a diagram of an example environment 400 in which systems and/or methods, described herein, may be implemented. As shown in FIG. 4, environment 400 may include a user device 410, a platform 420, and a network 430. Devices of environment 400 may interconnect via wired connections, wireless connections, or a combination of wired and wireless connections. In embodiments, any of the functions and operations described with reference to FIGS. 2 through 4 above may be performed by any combination of elements illustrated in FIG. 4.

User device 410 includes one or more devices capable of receiving, generating, storing, processing, and/or providing information associated with platform 420. For example, user device 410 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 410 may receive information from and/or transmit information to platform 420.

Platform 420 includes one or more devices capable of receiving, generating, storing, processing, and/or providing information. In some implementations, platform 420 may include a cloud server or a group of cloud servers. In some implementations, platform 420 may be designed to be modular such that certain software components may be swapped in or out depending on a particular need. As such, platform 420 may be easily and/or quickly reconfigured for different uses.

In some implementations, as shown, platform 420 may be hosted in cloud computing environment 422. Notably, while implementations described herein describe platform 420 as being hosted in cloud computing environment 422, in some implementations, platform 420 may not be cloud-based (i.e., may be implemented outside of a cloud computing environment) or may be partially cloud-based.

Cloud computing environment 422 includes an environment that hosts platform 420. Cloud computing environment 422 may provide computation, software, data access, storage, etc., services that do not require end-user (e.g., user device 410) knowledge of a physical location and configuration of system(s) and/or device(s) that hosts platform 420. As shown, cloud computing environment 422 may include a group of computing resources 424 (referred to collectively as “computing resources 424” and individually as “computing resource 424”).

Computing resource 424 includes one or more personal computers, a cluster of computing devices, workstation computers, server devices, or other types of computation and/or communication devices. In some implementations, computing resource 424 may host platform 420. The cloud resources may include compute instances executing in computing resource 424, storage devices provided in computing resource 424, data transfer devices provided by computing resource 424, etc. In some implementations, computing resource 424 may communicate with other computing resources 424 via wired connections, wireless connections, or a combination of wired and wireless connections.

As further shown in FIG. 4, computing resource 424 includes a group of cloud resources, such as one or more applications (“APPs”) 424-1, one or more virtual machines (“VMs”) 424-2, virtualized storage (“VSs”) 424-3, one or more hypervisors (“HYPs”) 424-4, or the like. While the current example embodiment is with reference to virtualized network functions, it is understood that one or more other embodiments are not limited thereto, and may be implemented in at least one of containers, cloud-native services, one or more container platforms, etc. For example, in one or more other example embodiments, any of the above-described components (e.g., nodes, E2 nodes, SMO functions, RIC, system, apparatus, etc.) may be a software-based component deployed or hosted in, for example, a server cluster such as a hybrid cloud server, data center servers, and the like. The software-based component may be containerized and may be deployed and controlled by one or more machines, called “nodes”, that run or execute the containerized network elements and are addressable. In this regard, a server cluster may contain at least one master node and a plurality of worker nodes, wherein the master node(s) controls and manages a set of associated worker nodes

Application 424-1 includes one or more software applications that may be provided to or accessed by user device 410. Application 424-1 may eliminate a need to install and execute the software applications on user device 410. For example, application 424-1 may include software associated with platform 420 and/or any other software capable of being provided via cloud computing environment 422. In some implementations, one application 424-1 may send/receive information to/from one or more other applications 424-1, via virtual machine 424-2.

Virtual machine 424-2 includes a software implementation of a machine (e.g., a computer) that executes programs like a physical machine. Virtual machine 424-2 may be either a system virtual machine or a process virtual machine, depending upon use and degree of correspondence to any real machine by virtual machine 424-2. A system virtual machine may provide a complete system platform that supports execution of a complete operating system (“OS”). A process virtual machine may execute a single program, and may support a single process. In some implementations, virtual machine 424-2 may execute on behalf of a user (e.g., user device 410), and may manage infrastructure of cloud computing environment 422, such as data management, synchronization, or long-duration data transfers.

Virtualized storage 424-3 includes one or more storage systems and/or one or more devices that use virtualization techniques within the storage systems or devices of computing resource 424. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 424-4 may provide hardware virtualization techniques that allow multiple operating systems (e.g., “guest operating systems”) to execute concurrently on a host computer, such as computing resource 424. Hypervisor 424-4 may present a virtual operating platform to the guest operating systems, and may manage the execution of the guest operating systems. Multiple instances of a variety of operating systems may share virtualized hardware resources.

Network 430 includes one or more wired and/or wireless networks. For example, network 430 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

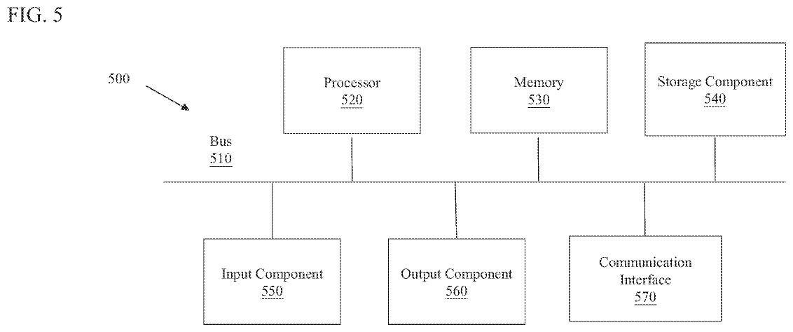

FIG. 5 is a diagram of example components of a device 500. Device 500 may correspond to user device 410 and/or platform 420. As shown in FIG. 5, device 500 may include a bus 510, a processor 520, a memory 530, a storage component 540, an input component 550, an output component 560, and a communication interface 570.

Bus 510 includes a component that permits communication among the components of device 500. Processor 520 may be implemented in hardware, firmware, or a combination of hardware and software. Processor 520 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 520 includes one or more processors capable of being programmed to perform a function. Memory 530 includes a random access memory (RAM), a read only memory (ROM), and/or another type of dynamic or static storage device (e.g., a flash memory, a magnetic memory, and/or an optical memory) that stores information and/or instructions for use by processor 520.

Storage component 540 stores information and/or software related to the operation and use of device 500. For example, storage component 540 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 550 includes a component that permits device 500 to receive information, such as via user input (e.g., a touch screen display, a keyboard, a keypad, a mouse, a button, a switch, and/or a microphone). Additionally, or alternatively, input component 550 may include a sensor for sensing information (e.g., a global positioning system (GPS) component, an accelerometer, a gyroscope, and/or an actuator). Output component 560 includes a component that provides output information from device 500 (e.g., a display, a speaker, and/or one or more light-emitting diodes (LEDs)).

Communication interface 570 includes a transceiver-like component (e.g., a transceiver and/or a separate receiver and transmitter) that enables device 500 to communicate with other devices, such as via a wired connection, a wireless connection, or a combination of wired and wireless connections. Communication interface 570 may permit device 500 to receive information from another device and/or provide information to another device. For example, communication interface 570 may include an Ethernet interface, an optical interface, a coaxial interface, an infrared interface, a radio frequency (RF) interface, a universal serial bus (USB) interface, a Wi-Fi interface, a cellular network interface, or the like.

Device 500 may perform one or more processes described herein. Device 500 may perform these processes in response to processor 520 executing software instructions stored by a non-transitory computer-readable medium, such as memory 530 and/or storage component 540. A computer-readable medium is defined herein as a non-transitory memory device. A memory device includes memory space within a single physical storage device or memory space spread across multiple physical storage devices.

Software instructions may be read into memory 530 and/or storage component 540 from another computer-readable medium or from another device via communication interface 570. When executed, software instructions stored in memory 530 and/or storage component 540 may cause processor 520 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 5 are provided as an example. In practice, device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

In embodiments, any of the operations or processes of FIGS. 2-3 may be implemented by or using any one of the elements illustrated in FIGS. 4 and 5. It is understood that other embodiments are not limited thereto, and may be implemented in a variety of different architectures (e.g., bare metal architecture, any cloud-based architecture or deployment architecture such as Kubernetes, Docker, OpenStack, etc.).

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

These computer readable program instructions may also be loaded onto a computer, other programmable data processing apparatus, or other devices to cause a series of operational steps to be performed on the computer, other programmable apparatus or other devices to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s), module, segment, or portion of instructions, which includes one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

### Various Aspects of Embodiments

Various further respective aspects and features of embodiments of the present disclosure may be defined by the following items:
Item [1]: A method for changing the status of an Open Radio Access Network (O-RAN) Cloud (O-Cloud) resource, the method comprising: obtaining, by a Service Management and Orchestration Framework (SMO) function, a first request or recommendation to update a functional status of an O-Cloud resource, the first request or recommendation being received from an rApp of a Non-Real-Time (Non-RT) RAN Intelligent Controller (RIC), or from an O-Cloud Maintainer, or from the SMO function directly; transmitting, by the SMO function to an Infrastructure Management Services (IMS), a second request to update the functional status of the O-Cloud resource based on the received first request or recommendation; and receiving, by the SMO function from the IMS, a first response as to whether the functional status of the O-Cloud resource was updated.
Item [2]: The method according to Item [1], wherein the first request or recommendation is determined based on metric and/or observability data received by the rApp or the O-Cloud Maintainer via O1- and/or O2-related services.
Item [3]: The method according to any one of Items [1]-[2], wherein the first response indicates that the functional status was successfully updated.
Item [4]: The method according to any one of Items [1]-[3], wherein the first response indicates that the O-Cloud resource could not be found and the functional status could not be updated.
Item [5]: The method according to any one of items [1]-[4], wherein the first response indicates that the functional status could not be updated and an unexpected error occurred.
Item [6]: The method according to any one of items [1]-[5], wherein the functional status update includes setting the O-Cloud resource into maintenance mode.
Item [7]: The method according to any one of items [1]-[6], further comprising:
   sending, by the SMO function, a second response to the rApp or O-Cloud maintainer based on the first response as to whether the functional status of the O-Cloud resource was updated.
Item [8]: An apparatus for changing the status of an Open Radio Access Network (O-RAN) Cloud (O-Cloud) resource, the apparatus comprising: at least one memory storing computer-executable instructions; and at least one processor configured to execute the computer-executable instructions to: obtain, by a Service Management and Orchestration Framework (SMO) function, a first request or recommendation to update a functional status of an O-Cloud resource, the first request or recommendation being obtained from an rApp of a Non-Real-Time (Non-RT) RAN Intelligent Controller (RIC), or from an O-Cloud Maintainer, or from the SMO function directly; transmit, by the SMO function to an Infrastructure Management Services (IMS), a second request to update the functional status of the O-Cloud resource based on the received first request or recommendation; and receive, by the SMO function from the IMS, a first response as to whether the functional status of the O-Cloud resource was updated.
Item [9]: The apparatus according to item [8], wherein the first request or recommendation is determined based on metric and/or observability data received by the rApp or the O-Cloud Maintainer via O1- and/or O2-related services.
Item [10]: The apparatus according to any one of items [8]-[9], wherein the first response indicates that the functional status was successfully updated.
Item [11]: The apparatus according to any one of items [8]-[10], wherein the first response indicates that the O-Cloud resource could not be found and the functional status could not be updated.
Item [12]: The apparatus according to any one of items [8]-[11], wherein the first response indicates that the functional status could not be updated and an unexpected error occurred.
Item [13]: The apparatus according to any one of items [8]-[12], wherein the functional status update includes setting the O-Cloud resource into maintenance mode.
Item [14]: The apparatus according to any one of items [8]-[13], wherein the at least one processor is further configured to execute the computer-executable instructions to: send, by the SMO function, a second response to the rApp or O-Cloud maintainer based on the first response as to whether the functional status of the O-Cloud resource was updated.
Item [15]: A non-transitory computer-readable recording medium having recorded thereon instructions executable by at least one processor to cause the processor to perform a method comprising: obtaining, by a Service Management and Orchestration Framework (SMO) function, a first request or recommendation to update a functional status of an O-Cloud resource, the first request or recommendation being obtained from an rApp of a Non-Real-Time (Non-RT) RAN Intelligent Controller (RIC), or from an O-Cloud Maintainer, or from the SMO function directly; transmitting, by the SMO function to an Infrastructure Management Services (IMS), a second request to update the functional status of the O-Cloud resource based on the received first request or recommendation; and receiving, by the SMO function from the IMS, a first response as to whether the functional status of the O-Cloud resource was updated.
Item [16]: The non-transitory computer-readable recording medium according to item [15], wherein the first request or recommendation is determined based on metric and/or observability data received by the rApp or the O-Cloud Maintainer via O1- and/or O2-related services.
Item [17]: The non-transitory computer-readable recording medium according to any one of items [15]-[16], wherein the first response indicates that the functional status was successfully updated.
Item [18]: The non-transitory computer-readable recording medium according to any one of items [15]-[17], wherein the first response indicates that the O-Cloud resource could not be found and the functional status could not be updated.
Item [19]: The non-transitory computer-readable recording medium according to any one of items [15]-[18], wherein the first response indicates that the functional status could not be updated and an unexpected error occurred.
Item [20]: The non-transitory computer-readable recording medium according to any one of items [15]-[19], wherein the functional status update includes setting the O-Cloud resource into maintenance mode.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A method for changing the status of an Open Radio Access Network (O-RAN) Cloud (O-Cloud) resource, the method comprising:
obtaining, by a Service Management and Orchestration Framework (SMO) function, a first request or recommendation to update a functional status of an O-Cloud resource, the first request or recommendation being obtained from an rApp of a Non-Real-Time (Non-RT) RAN Intelligent Controller (RIC), or from an O-Cloud Maintainer, or from the SMO function directly;
transmitting, by the SMO function to an Infrastructure Management Services (IMS), a second request to update the functional status of the O-Cloud resource based on the received first request or recommendation; and
receiving, by the SMO function from the IMS, a first response as to whether the functional status of the O-Cloud resource was updated.

2. The method as claimed in claim 1, wherein the first request or recommendation is determined based on metric and/or observability data received by the rApp or the O-Cloud Maintainer via O1- and/or O2-related services.

3. The method as claimed in claim 1, wherein the first response indicates that the functional status was successfully updated.

4. The method as claimed in claim 1, wherein the first response indicates that the O-Cloud resource could not be found and the functional status could not be updated.

5. The method as claimed in claim 1, wherein the first response indicates that the functional status could not be updated and an unexpected error occurred.

6. The method as claimed in claim 1, wherein the functional status update comprises setting the O-Cloud resource into maintenance mode.

7. The method as claimed in claim 1, further comprising:
sending, by the SMO function, a second response to the rApp or O-Cloud maintainer based on the first response as to whether the functional status of the O-Cloud resource was updated.

8. An apparatus for changing the status of an Open Radio Access Network (O-RAN) Cloud (O-Cloud) resource, the apparatus comprising:
at least one memory storing computer-executable instructions; and
at least one processor configured to execute the computer-executable instructions to:
obtain, by a Service Management and Orchestration Framework (SMO) function, a first request or recommendation to update a functional status of an O-Cloud resource, the first request or recommendation being obtained from an rApp of a Non-Real-Time (Non-RT) RAN Intelligent Controller (RIC), or from an O-Cloud Maintainer, or from the SMO function directly;
transmit, by the SMO function to an Infrastructure Management Services (IMS), a second request to update the functional status of the O-Cloud resource based on the received first request or recommendation; and
receive, by the SMO function from the IMS, a first response as to whether the functional status of the O-Cloud resource was updated.

9. The apparatus as claimed in claim 8, wherein the first request or recommendation is determined based on metric and/or observability data received by the rApp or the O-Cloud Maintainer via O1- and/or O2-related services.

10. The apparatus as claimed in claim 8, wherein the first response indicates that the functional status was successfully updated.

11. The apparatus as claimed in claim 8, wherein the first response indicates that the O-Cloud resource could not be found and the functional status could not be updated.

12. The apparatus as claimed in claim 8, wherein the first response indicates that the functional status could not be updated and an unexpected error occurred.

13. The apparatus as claimed in claim 8, wherein the functional status update comprises setting the O-Cloud resource into maintenance mode.

14. The apparatus as claimed in claim 13, wherein the at least one processor is further configured to execute the computer-executable instructions to:
send, by the SMO function, a second response to the rApp or O-Cloud maintainer based on the first response as to whether the functional status of the O-Cloud resource was updated.

15. A non-transitory computer-readable recording medium having recorded thereon instructions executable by at least one processor to cause the processor to perform a method comprising:
obtaining, by a Service Management and Orchestration Framework (SMO) function, a first request or recommendation to update a functional status of an O-Cloud resource, the first request or recommendation being obtained from an rApp of a Non-Real-Time (Non-RT) RAN Intelligent Controller (RIC), or from an O-Cloud Maintainer, or from the SMO function directly;
transmitting, by the SMO function to an Infrastructure Management Services (IMS), a second request to update the functional status of the O-Cloud resource based on the received first request or recommendation; and
receiving, by the SMO function from the IMS, a first response as to whether the functional status of the O-Cloud resource was updated.

16. The non-transitory computer-readable recording medium as claimed in claim 15, wherein the first request or recommendation is determined based on metric and/or observability data received by the rApp or the O-Cloud Maintainer via O1- and/or O2-related services.

17. The non-transitory computer-readable recording medium as claimed in claim 15, wherein the first response indicates that the functional status was successfully updated.

18. The non-transitory computer-readable recording medium as claimed in claim 15, wherein the first response indicates that the O-Cloud resource could not be found and the functional status could not be updated.

19. The non-transitory computer-readable recording medium as claimed in claim 15, wherein the first response indicates that the functional status could not be updated and an unexpected error occurred.

20. The non-transitory computer-readable recording medium as claimed in claim 15, wherein the functional status update comprises setting the O-Cloud resource into maintenance mode.
